(19) United States
(12) Patent Application Publication
(10) Pub. No.: US 2022/0390670 A1
(43) Pub. Date: Dec. 8, 2022

(54) Optical Module

(71) Applicant: Nippon Telegraph and Telephone Corporation, Tokyo (JP)

(72) Inventors: Yuji Fujiwara, Musashino-shi, Tokyo (JP); Ryoichi Kasahara, Musashino-shi, Tokyo (JP); Katsuhiko Hirabayashi, Musashino-shi, Tokyo (JP)

(21) Appl. No.: 17/776,060

(22) PCT Filed: Nov. 20, 2019
(86) PCT No.: PCT/JP2019/045455

§ 371 Date: May 11, 2022

(51) Int. Cl. G02B 6/125; G02B 6/30; G02B 6/293

(52) U.S. Cl. CPC G02B 6/125; G02B 6/30; G02B 6/29325

(57) ABSTRACT

An optical module capable of suppressing deterioration of an adhesive layer and having a resistance to high-power light even when high-energy light propagates is configured by connecting an optical fiber to a PLC. The optical fiber is provided with an etching face at a recessed area where a cladding region on its side face is partially removed over a length L in a light propagation direction from an input/output end connected to the PLC, and the PLC is also provided with an etching face at a recessed area where a cladding layer is partially removed over the length L in the light propagation direction from an input/output end connected to the optical fiber. The adhesive layer made of a UV cured resin is interposed between the etching faces to bond and fix the etching faces to each other, and a core of the optical fiber and a core layer of the PLC form a directional coupler for linearly dispersing energy density.

### TECHNICAL FIELD

The present invention relates to an optical module configured by connecting an optical communication device such as an optical fiber to a planar lightwave circuit (hereinafter referred to as PLC).

### BACKGROUND ART

The PCL has been a core technology for optical communication and optical signal processing systems in the related art. In current communication networks, the PLC has been actively used. For example, devices such as splitters for branching light, light switches for switching paths of optical signals, lasers to become light sources, and modulators are implemented by the PLC in a broad sense.

The PLC is composed of a quartz-based material, a silicon-based material, a semiconductor-based material, and the like, and usually, is less used as a single product but is often used as an optical module in which an optical fiber is connected as an optical communication device. In aligning the PLC with the optical fiber and secured by adhesion, a fiber block made of glass or the like is used in order to increase the cross sectional area of adhesion and enhance the mechanical strength of the adhering part.

A case of using a V-groove glass substrate can be illustrated as the fiber block, and a ferrule and the like can also be used in other cases. The optical fiber is secured to such a fiber block or ferrule, and the fiber block or the ferrule is adhered to the PLC. As described in PTL 1, for example, the adhesion of the fiber block or the ferrule to the PLC by using an ultraviolet (UV) cured resin adhesive can be illustrated by examples. Specifically, the UV cured resin adhesive is filled into a gap between optical connecting parts, and alignment is made so as to maximize the optical coupling ratio by using a fine alignment device, and then the UV cured resin adhesive is irradiated with UV light to cure.

The UV cured resin adhesive is cured within several minutes after irradiation with UV light, and thus its curing time is significantly shorter than that of the room temperature curing adhesive, the two-part adhesive, and the like, which are left for several hours to be cured. Therefore, the production throughput required for optical connection (indicating the amount that can be processed within a unit time) is improved by using the UV cured resin adhesive. In addition, since the UV cured resin adhesive is a resin, the refractive index of the UV cured resin adhesive, which greatly affects the optical connection loss, can be adjusted to match the refractive index of a core layer at an emission end face of the PLC. From such advantages, the UV cured resin adhesive is often used for the optical connection between the optical fiber and the PLC.

In recent years, the PLC has been expected to be used as an image and sensor device because of small man-hour for alignment and strong resistance to vibrations. With the expansion of PLC applications, for light propagating in the PLC, there is also an increasing demand for using light in the communication wavelength range as well as light in the visible wavelength range. Due to such backgrounds, countermeasures for propagating visible light are required for components that constitute the optical module, such as the PLC and the optical communication device, as well as the optical connecting part that connects them.

In the known optical connection technology, the UV curable adhesive is used between the optical connecting parts as in PTL 1, but the UV cured resin adhesive is known to absorb high-energy visible light (having shorter wavelengths and higher energy than light in the communication wavelength range) and thus deteriorate. Even in the communication wavelength range, this light absorption occurs by propagation of high power light of a few mW order to the UV cured resin adhesive. In order to suppress such deterioration, it has been proposed that only a portion through which light does not pass in the adhering portion between the PLC and the optical fiber is secured by means of the UV cured resin adhesive, and a portion through which light passes is formed of a cavity. However, in adopting this connection method, dust collects in the cavity through which light passes, disadvantageously increasing optical connection loss.

Therefore, as described in NPL 1, a method for filling a portion through which light passes in the adhering portion with quartz-based glass has been proposed. For example, an example of a simple method is a method of using polysilazane. Polysilazane is an inorganic polymer material having SiH₂NH as a basic unit and is cured by reacting with water and converted to SiO₂ glass.

However, when polysilazane is used as a filler for the optical connecting part, the region to be filled is a small cavity between the PLC and the optical fiber, and it is difficult to sufficiently supply water necessary for the conversion of polysilazane into SiO₂ glass. That is, if water is not sufficiently supplied, a problem occurs in that unreacted polysilazane remains.

Furthermore, as described in NPL 1, polysilazane has the property of converting into silicon nitride when irradiated with high-energy light in an inert atmosphere. Therefore, the conversion into silicon nitride may gradually occur at an optical axis, causing an axial shift due to changes in stress. Further, the refractive index of silicon nitride is approximately 2.0 at a wavelength of 630 nm, which is significantly different from the refractive index of SiO₂ glass of 1.458 under similar conditions. Thus, as conversion into silicon nitride proceeds, Fresnel losses may increase over time.

As described above, in propagating high-energy light such as visible light, the existing optical connection technology has the problem of the deterioration of the adhesive not being able to be suppressed, failing to realize an optical module with long-term reliability.

### CITATION LIST

### Patent Literature

PTL 1: JP 2014-048628 A

### Non Patent Literature

NPL 1: “Spin-on silicon-nitride Films for Photo lithography by RT Cure of Polysilazane”, N. Shinde, Y. Takano, J. Sagan, V. Monreal, T. Nagahara, Journal of Photopolymer science and Technology, Vol. 23, No. 2, pp. 225-230, 2010.

### SUMMARY OF THE INVENTION

The present invention has been made to solve the above problems and issues. An object of an embodiment of the present invention is to provide an optical module capable of suppressing deterioration of an adhesive layer and having resistance to high-power light even when high-energy light propagates.

To achieve the object described above, an aspect of the present invention is an optical module comprising: at least one optical waveguide; at least one planar lightwave circuit, each of which is optically connected to a corresponding one of the at least one optical waveguide; and an adhesive layer configured to adhesively bond the optical waveguide to the planar lightwave circuit, wherein a cladding region of the optical waveguide is partially removed in a region having a predetermined length in a light propagation direction from an input/output end, a cladding region of the planar lightwave circuit is partially removed in a region having the predetermined length in the light propagation direction from an input/output end, and a core of the optical waveguide and a core of the planar lightwave circuit are arranged to form a directional coupler.

With the above-described configuration, the deterioration of the adhesive layer can be suppressed by linearly dispersing the energy density of high-power light via the directional coupler. As a result, it is possible to provide an optical module capable of having a resistance to high-power light even when high-energy light propagates, significantly contributing to a demand for the expansion of applications of the PLC.

### BRIEF DESCRIPTION OF DRAWINGS

FIG. 1 is a plan view illustrating an optical module according to a first embodiment of the present invention when viewed from directly above.

FIG. 2 is a view illustrating a cross section of the optical module taken along a line II-II in FIG. 1, which is parallel to an end face of the optical module.

FIG. 3 is a view illustrating a cross section of the optical module taken along a line III-III in FIG. 1, which is parallel to a side face of the optical module.

FIG. 4 is a plan view illustrating an optical module according to a second embodiment of the present invention when viewed from directly above.

FIG. 5 is a view illustrating a cross section of the optical module taken along a line V-V in FIG. 4, which is parallel to an end face of the optical module.

FIG. 6 is a view illustrating a cross section of the optical module taken along a line VI-VI in FIG. 4, which is parallel to a side face of the optical module.

FIG. 7 is a view illustrating a cross section of an optical module according to a third embodiment of the present invention, which is parallel to an end face of the optical module.

### DESCRIPTION OF EMBODIMENTS

Hereinafter, an optical module according to some embodiments of the present invention will be described in detail with reference to the drawings.

### First Embodiment

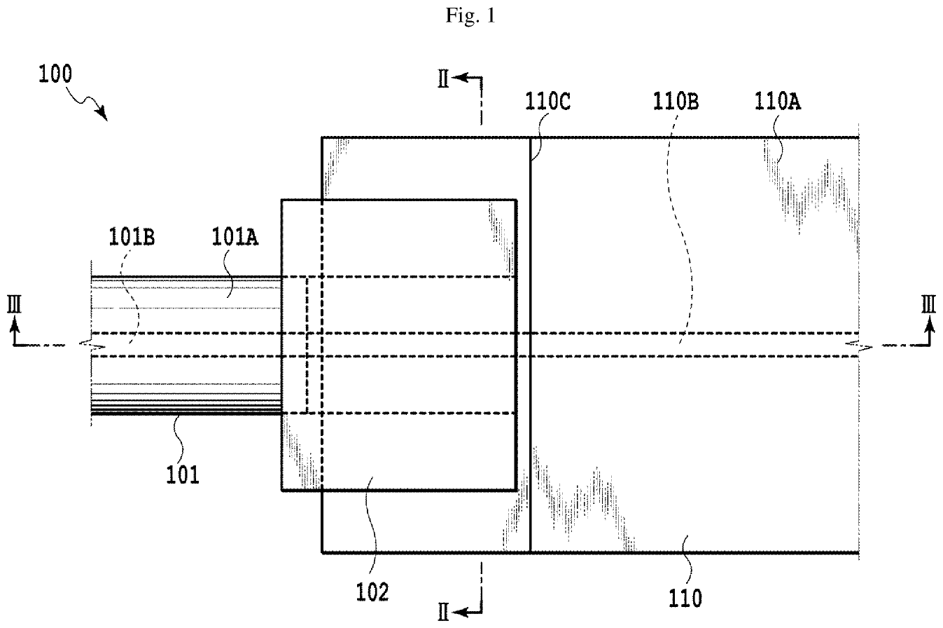

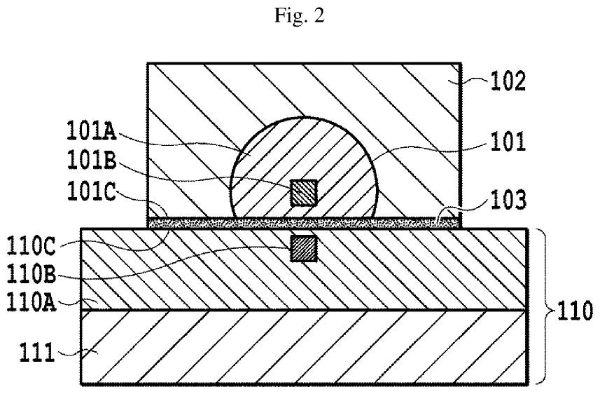

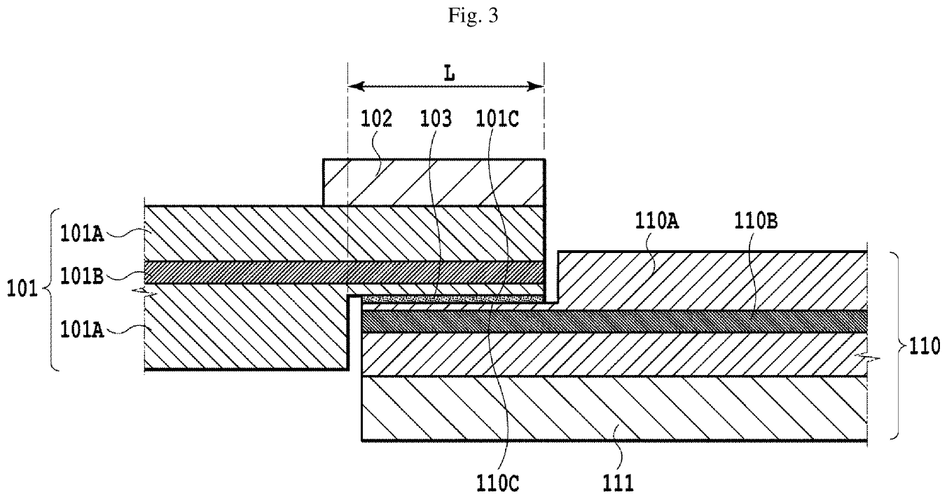

FIG. 1 is a plan view illustrating an optical module 100 according to a first embodiment of the present invention when viewed from directly above. FIG. 2 is a view illustrating a cross section of the optical module 100 taken along a line II-II in FIG. 1, which is parallel to an end face of the optical module. FIG. 3 is a view illustrating a cross section of the optical module 100 taken along a line III-III in FIG. 1, which is parallel to a side face of the optical module.

With reference to the figures, the optical module 100 includes an optical fiber 101, a fiber block 102 which the optical fiber 101 is inserted into and fixed to, and a PLC 110 connected to the fiber block 102 to which the optical fiber 101 is fixed.

Of these components, the optical fiber 101 is configured by covering the periphery of a core 101B with a cladding region 101A. The PLC 110 is configured by covering a core layer 110B with a cladding layer 110A on an upper face of a support substrate 111. Further, the optical fiber 101 and PLC 110 are bonded and fixed to each other by use of a UV cured resin adhesive layer 103. Note that in the first embodiment, the core 101B is present in the optical fiber 101 and the core layer 110B is present in the PLC 110, but these may be referred to simply as the core.

Further, as illustrated in FIGS. 2 and 3, in the optical module 100, the cladding region 101A on the side face is partially removed over a predetermined length L in a light propagation direction from an input/output end connected to the PLC 110, such that the optical fiber 101 becomes recessed. As a result, the optical fiber 101 is provided with a flat etching face 101C at the recessed area, and the core 101B is positioned away from the etching face 101C by approximately 5 μm or less. As illustrated in FIG. 3, a connecting-side end face of the cladding region 101A having the etching face 101C is flush with a connecting-side end face of the fiber block 102.

Further, in the optical module 100, similarly to the optical fiber 101, the cladding layer 110A is partially removed over the predetermined length L in a light propagation direction from an input/output end connected to the optical fiber 101, such that the PLC 110 becomes recessed. As a result, the PLC 110 is also provided with a flat etching face 110C at the recessed area. The cladding region 101A of the optical fiber 101 and the cladding layer 110A of the PLC 110 may simply be referred to as a cladding region.

In the optical module 100, the etching face 101C of the optical fiber 101 and the etching face 110C of the PLC 110 are bonded and fixed to each other by interposing the UV cured resin adhesive layer 103 therebetween. These etching faces 101C and 110C are subjected to adhesion and thus, may be also referred to as adhesive faces. Thus, in the optical module 100, the core 101B of the optical fiber 101 and the core layer 110B of the PLC 110 form a directional coupler via the UV cured resin adhesive layer 103.

The predetermined length L described above may be long enough to allow the core layer 110B of PLC 110 and the core 101B of the optical fiber 101 to form the directional coupler. That is, the predetermined length L may be set in consideration of the size of the core 101B and the core layer 110B, a difference in the refractive index between them, the thickness of the UV cured resin adhesive layer 103 between the core 101B and the core layer 110B, and the like.

In short, the optical module 100 according to the first embodiment is configured by connecting the optical fiber 101 to the PLC 110. The core 101B of the optical fiber 101 and the core layer 110B of the PLC 110 are optical waveguides separately provided in optical fibers 101 and PLC 110, respectively. In the optical module 100, the optical fiber 101 is inserted into and fixed to the fiber block 102. As illustrated in FIG. 2, the core 101B of the optical fiber 101 and the core layer 110B of the PLC 110 are rectangular in a region of at least the predetermined length L in the light propagation direction from the connecting-side end.

In the optical module 100 according to the first embodiment, the core 101B of the optical fiber 101 and the core layer 110B of the PLC 110 have the rectangular shape, but other shapes such as circular, elliptic, or the like may be used. Further, in the optical module 100 according to the first embodiment described above, the etching face 101C of the optical fiber 101 and the etching face 110C of the PLC 110 are bonded and fixed to each other by interposing the UV cured resin adhesive layer 103 therebetween. However, the UV cured resin adhesive layer 103 is an example, and instead of a UV curing resin, a thermosetting resin, a quartz-based glass, or the like may be used as an adhesive material in the adhesive layer, to adhesively bond the etching faces to each other.

The following describes a method for producing the optical module 100 according to the first embodiment. For example, the PLC 110 may be produced by the following procedure. First, an undercladding layer composed of quartz glass with a thickness of 20 μm, and a core layer composed of quartz glass having a thickness of 2 μm with a refractive index increased by germanium Ge doping are sequentially deposited on an upper face of a silicon Si substrate serving as the support substrate 111.

Next, the core layer is shaped into a pattern for an optical waveguide by using general exposure development technique and etching technique to form the rectangular core layer 110B. After that, an overcladding layer made from a quartz glass material is deposited by 20 μm to form an optical waveguide of the rectangular core layer 110B. Further, a wafer for the PLC 110 is cut into a chip of 5×10 mm. By this, an original form of the PLC 110 is created.

In addition, the overcladding layer in a region having the predetermined length L in the light propagation direction from an input/output end of the chip is partially removed by polishing or dry etching to form the thin film-like etching face 110C. This creates the cladding layer 110A as illustrated in FIGS. 2 and 3, and here, the core layer 110B of the PLC 110 is disposed away from the etching face 110C by 5 μm or less. The single PLC 110 is produced in this manner. The reason why the core layer 110B of PLC 110 is disposed away from the etching face 110C by 5 μm or less is that the directional coupler is easily formed between the core layer of the PLC and the core 101B of the optical fiber 101.

To produce the fiber block 102, first, a fiber-fixing V groove having a diameter of ϕ=125 μm is formed on a 5×5 mm glass plate having a thickness of 1 mm by machining. The optical fiber 101 is mounted to the V-groove substrate having the V groove, and the optical fiber 101 mounted to the V-groove substrate is sandwiched between two 5 mm×3 mm glass plates having a thickness of 1 mm. Thereafter, gaps between the two glass plates and the optical fiber 101 sandwiched therebetween are filled with a UV cured resin adhesive for adhesion, and irradiated with UV light to be fixed, and then the end face is polished. This completes the configuration in which the optical fiber 101 is inserted into and fixed to the fiber block 102. However, such a procedure has similarly been applied in well-known techniques.

In the case of the optical module 100, further, the side face of the cladding region 101A of the optical fiber 101 is partially removed in a region having the predetermined length L in the light propagation direction from the input/output end by polishing or dry etching to form the thin film-like etching face 101C. This creates the cladding region 101A as illustrated in FIGS. 2 and 3, and here, the core 101B of the optical fiber 101 is disposed away from the etching face 101C by 5 μm or less. The single optical module 100 alone is completed by such a procedure. The reason why the core 101B of the optical fiber 101 is disposed away from the etching face 101C by 5 μm or less is that the directional coupler is easily formed between the core of the optical fiber and the core layer 110B of the PLC 110.

When each portion constituting the optical module 100 is produced, the PLC 110 and the fiber block 102 to which the optical fiber 101 is fixed are mounted on a fine alignment device and secured. Then, as illustrated in FIGS. 2 and 3, the connecting position is adjusted in the state where the etching face 110C of the PLC 110 is separated from the etching face 101C of the optical fiber 101 fixed to the fiber block 102 by approximately 1 μm. Thereafter, the UV cured resin adhesive is applied between the etching faces 101C and 110C, and then, the UV cured resin adhesive spread at the connecting portion between the PLC 110 and the optical fiber 101 is irradiated with UV light to be cured. As a result, the UV cured resin adhesive layer 103 is formed, and the PLC 110 is bonded and fixed to the optical fiber 101 inserted into and fixed to the fiber block 102. In this manner, the optical module 100 according to the first embodiment is produced.

The optical module 100 according to the first embodiment described above is configured such that optical connection between the optical fibers 101 and the PLC 110 is performed by using the directional coupler formed of the core 101B of the optical fiber 101 and the core layer 110B of the PLC 110. Therefore, the optical power responded by the adhesive layer of the optical connecting part of the optical fibers 101 and the PLC 110 can be linearly dispersed and greatly reduced, thereby suppressing photochemical reaction generated in the adhesive layer. As a result, since deterioration of the adhesive layer is suppressed, even when high-energy light such as visible light propagates in the optical module 100, deterioration of the adhesive layer can be suppressed to ensure long-term reliability. That is, even when high-energy light propagates, the optical module 100 resistant to high-power light can be embodied, significantly contributing to the demand for the expansion of applications of the PLC 110.

Note that, for simplification of description, the optical module 100 according to the first embodiment is configured such that one optical fiber 101 is connected to the input/output end. However, the configuration of the optical module 100 is not limited to this, and various modifications can be made, and are configured to fall within the technical scope of the first embodiment. For example, a plurality of V grooves for fixedly inserting a plurality of optical fibers 101 into the fiber block 102 may be formed, a plurality of optical waveguides may be formed in the PLC 110, and the plurality of optical fibers 101 may be connected to the respective input/output ends of the optical waveguides.

### Second Embodiment

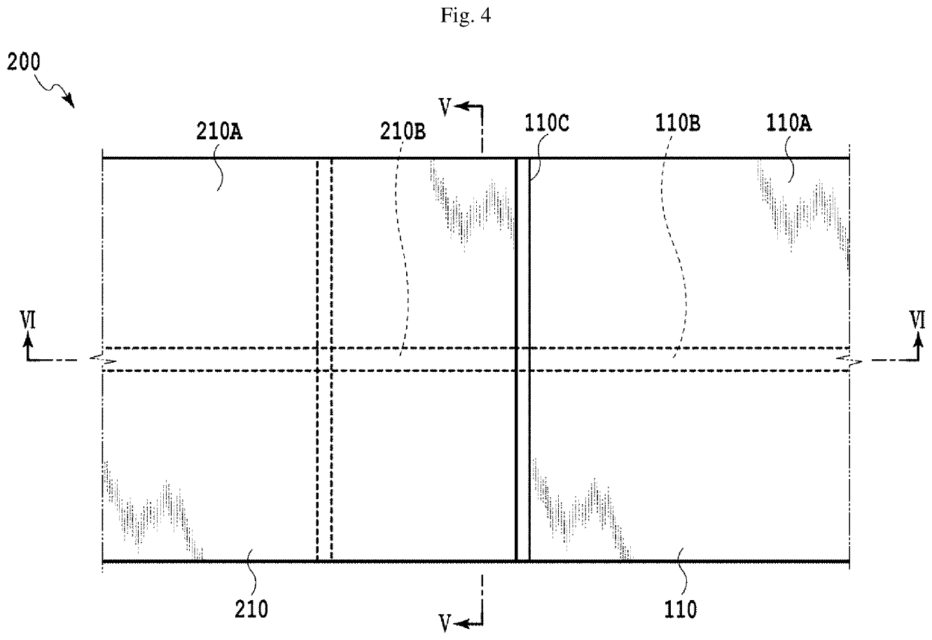

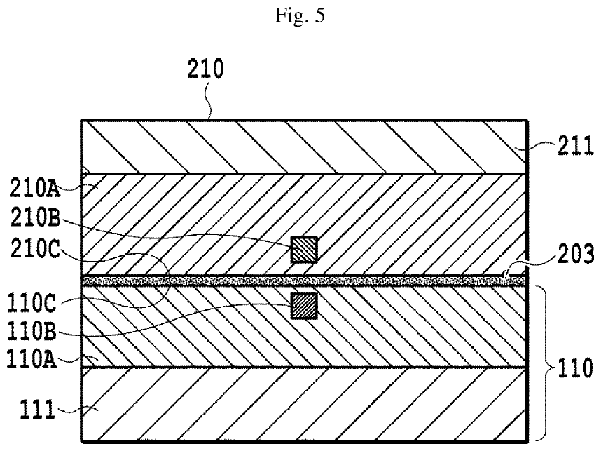

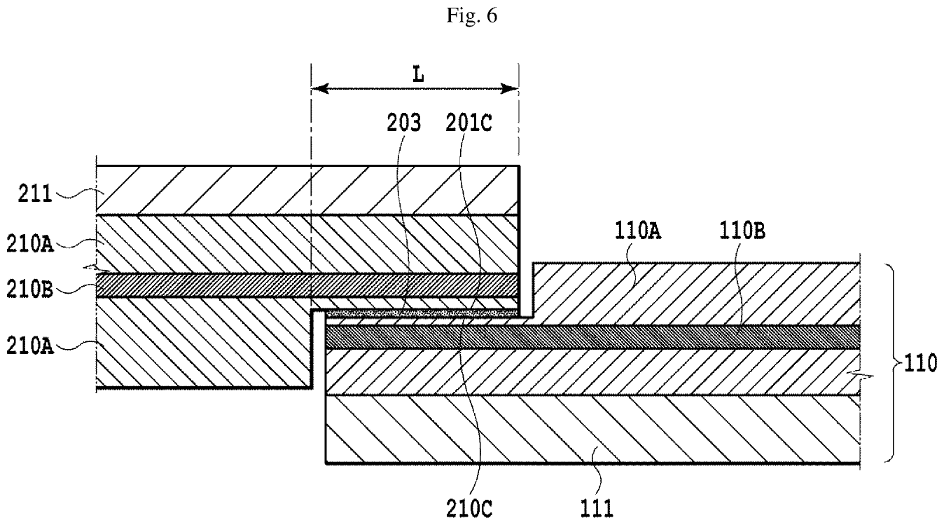

FIG. 4 is a plan view illustrating an optical module 200 according to a second embodiment of the present invention when viewed from directly above. FIG. 5 is a view illustrating a cross section of the optical module 200 taken along a line V-V in FIG. 4, which is parallel to an end face of the optical module. FIG. 6 is a view illustrating a cross section of the optical module 200 taken along a line VI-VI in FIG. 4, which is parallel to a side face of the optical module.

Referring to the figures, the optical module 200 is configured by connecting a pair of PLCs 110 and 210 to each other. The PLC 110 has the same configuration as that of the first embodiment, and thus the same reference numerals will be assigned and descriptions thereof will be omitted. Here, the optical module 200 is configured to use the PLC 210 in place of the optical fiber 101 in the first embodiment.

The cladding layer 210A is partially removed over a predetermined length L in a light propagation direction from an input/output end connected to the PLC 110, such that the PLC 210 becomes recessed. As a result, the PLC 210 is also provided with a flat etching face 210C at the recessed area. Note that the cladding layer 110A of the PLC 110 and the cladding layer 210A of and PLC 210 may simply be referred to as a cladding region.

In the optical module 200, the etching face 110C of the PLC 110 and the etching face 210C of the PLC 210 are bonded and fixed to each other by interposing a UV cured resin adhesive layer 203 therebetween. These etching faces 110C and 210C are subjected to adhesion and thus, may be also referred to as adhesive faces. Thus, in the optical module 200, the core layer 110B of the PLC 110 and the core layer 210B of the PLC 210 form a directional coupler via the UV cured resin adhesive layer 203. Note that, also in the second embodiment, the core layer 110B is present in the PLC 110 and the core layer 210B is present in the PLC 210, but these may be referred to simply as the core.

The predetermined length L described above may be long enough to allow the core layer 110B of PLC 110 and the core layer 210B of the PLC 210 to form the directional coupler. That is, the predetermined length L may be set in consideration of the size of the core layer 110B and the core layer 210B, a difference in the refractive index between them, the thickness of the UV cured resin adhesive layer 203 between the core layer 110B and the core layer 210B, and the like.

In short, the optical module 200 according to the second embodiment is configured by connecting the pair of PLCs 110 and 210 to each other. The core layer 110B of the PLC 110 and the core layer 210B of the PLC 210 are optical waveguides separately provided in the PLCs 110 and 210, respectively. The optical module 200 requires no fiber block 102 used in the first embodiment. As illustrated in FIG. 5, the core layer 110B of the PLC 110 and the core layer 210B of the PLC 210 are rectangular in a region having at least the predetermined length L in the light propagation direction from the connecting-side end.

For production of the optical module 200, the PLC 210 can be produced in the procedure and technical considerations similar to those applied to the PLC 110 described in the first embodiment, and thus description thereof is omitted.

In the optical module 200 according to the second embodiment, the core layer 110B of the PLC 110 and the core layer 210B of the PLC 210 have the rectangular shape, but other shapes such as circular, elliptic, or the like may be used. Further, in the optical module 200 according to the second embodiment described above, the etching face 110C of the PLC 110 and the etching face 210C of the PLC 210 are bonded and fixed to each other by interposing the UV cured resin adhesive layer 203 therebetween. However, the UV cured resin adhesive layer 203 is an example, and instead of a UV curing resin, a thermosetting resin, a quartz-based glass, or the like may be used as an adhesive material in the adhesive layer, to adhesively bond the same area.

The optical module 200 according to the second embodiment described above is configured such that optical connection between the pair of PLCs 110 and 210 is performed by using the directional coupler formed of the core layer 110B of the PLC 110 and the core layer 210B of the PLC 210. Therefore, the optical power responded by the adhesive layer of the optical connecting part of the PLCs 110 and 210 can be linearly dispersed and greatly reduced, thereby suppressing photochemical reaction generated in the adhesive layer. As a result, since deterioration of the adhesive layer is suppressed, as in the first embodiment, even when high-energy light such as visible light propagates in the optical module 200, long-term reliability can be ensured. That is, even when high-energy light propagates, the optical module 200 resistant to high-power light can be embodied, significantly contributing to the demand for the expansion of applications of the PLCs 110 and 210.

### Third Embodiment

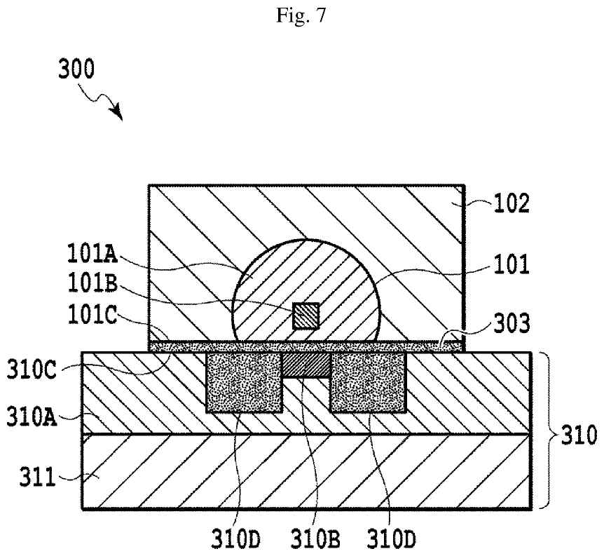

FIG. 7 is a view illustrating a cross section of an optical module 300 according to a third embodiment of the present invention, which is parallel to an end face of the optical module.

With reference to FIG. 7, the optical module 300 is configured by connecting an optical fiber 101 and a PLC 310 having rib-type waveguide structure. The optical fiber 101 to be inserted into and fixed to the fiber block 102 has the same configuration as that of the first embodiment, and thus the same reference numerals will be assigned and descriptions thereof will be omitted. Here, the optical module 300 is configured to use, instead of the PLC 110 in the first embodiment, the PLC 310 of rib-type waveguide structure having a recessed portion 310D recessed on both side faces of a core layer 310B. Note that, also in the third embodiment, the core 101B is present in the optical fiber 101 and the core layer 310B is present in the PLC 310, but these may be referred to simply as the core.

The dimension of the PLC 310 in the width direction perpendicular to the thickness direction in the core layer 310B is greater than the dimension of the optical fiber 101 in the width direction perpendicular to the thickness direction in the core 101B. The thickness direction and the width direction of the core layer 310B are defined on a plane perpendicular to the length direction in which the core layer 310B extends. Further, the thickness direction and the width direction of the core 101B of the optical fiber 101 are defined on a plane perpendicular to the length direction in which the core 101B extends. Since the PLC 310 has the rib-type waveguide structure, a cladding layer 310A on an upper face of the support substrate 311 has the recessed portion 310D recessed on the side of both side faces of the core layer 310B.

Further, also in the PLC 310, the cladding layer 310A is partially removed over a predetermined length L in a light propagation direction from an input/output end connected to the optical fiber 101, such that the PLC 310 becomes recessed. As a result, the PLC 310 is also provided with a flat etching face 310C at the recessed area. The cladding region 101A of the optical fiber 101 and the cladding layer 310A of and PLC 310 may simply be referred to as a cladding region.

In the optical module 300, a UV cured resin adhesive layer 303 adhesively bonds the etching face 101C of the optical fiber 101 to the etching face 310C of the PLC 310, including the filling area of the recessed portion 310D of the PLC 310. These etching faces 101C and 310C are subjected to adhesion and thus, may be also referred to as adhesive faces. As a result, optical connection between the optical fiber 101 and the PLC 310 is performed by using a directional coupler formed of the core 101B of the optical fiber 101 and the core layer 310B of the PLC 310.

In short, the optical module 300 according to the third embodiment is configured by connecting the optical fiber 101 to the PLC 310. The core 101B of the optical fiber 101 and the core layer 310B of the PLC 310 are optical waveguides separately provided in the optical fiber 101 and the PLC 310, respectively. In the optical module 300, the optical fiber 101 is inserted into and fixed to the fiber block 102. This embodiment is the same as the first embodiment in that, as illustrated in FIG. 7, the core 101B of the optical fiber 101 and the core layer 310B of the PLC 310 are rectangular in a region of at least the predetermined length L in the light propagation direction from the connecting-side end.

The production of the optical module 300 in this embodiment is partially different from the production of the optical module 100 in the first embodiment due to the change in the shape of the PLC 310. The PLC 310 may be produced by performing the initial deposition described in the production of the PLC 110 in the first embodiment and then applying general exposure and development technique and etching technique. That is, the cladding layer and the core layer are deposited on the upper face of the support substrate 311 and then, the core layer is shaped into a pattern for the optical waveguide, and the rectangular core layer 110B and the recessed portion 310D on both side faces of the core layer are formed. However, the core layer 310B is exposed to the etching face 301C.

Thereafter, the UV cured resin adhesive with which the entire recessed portion 310D is filled is applied between the etching faces 101C and 310C, and then, the UV cured resin adhesive spread at the connecting portion between the PLC 310 and the optical fiber 101 is irradiated with UV light to be cured. Except for these steps, the procedure and technical matters similar to those applied to the production of the optical module 100 described in the first embodiment can be applied, and thus descriptions thereof will be omitted.

In the optical module 300 according to the third embodiment, the core 101B of the optical fiber 101 and the core layer 310B of the PLC 310 have the rectangular shape, but other shapes such as circular, elliptic, or the like may be used. Further, in the optical module 300 according to the third embodiment described above, the etching face 101C of the optical fiber 101 and the etching face 310C of the PLC 310 are bonded and fixed to each other by interposing the UV cured resin adhesive layer 303 therebetween. However, the UV cured resin adhesive layer 303 is an example, and instead of a UV curing resin, a thermosetting resin, a quartz-based glass, or the like may be used as an adhesive material in the adhesive layer, to adhesively bond the same area.

The optical module 300 according to the third embodiment described above is configured such that optical connection between the optical fibers 101 and the PLC 310 is performed by using the directional coupler formed of the core 101B of the optical fiber 101 and the core layer 310B of the PLC 310. Therefore, the optical power responded by the adhesive layer of the optical connecting part of the optical fibers 101 and the PLC 310 can be linearly dispersed and greatly reduced, thereby suppressing photochemical reaction generated in the adhesive layer. As a result, since deterioration of the adhesive layer is suppressed, as in the first embodiment, even when high-energy light such as visible light propagates in the optical module 300, long-term reliability can be ensured. That is, even when high-energy light propagates, the optical module 300 resistant to high-power light can be embodied, significantly contributing to the demand for the expansion of applications of the PLC 310.

Note that, for simplification of description, the optical module 300 according to the third embodiment illustrates a configuration of one optical fiber 101 being connected to the input/output end. However, the configuration of the optical module 300 is not limited to this, and various modifications can be made, and are configured to fall within the technical scope of the third embodiment. For example, a plurality of V grooves for fixedly inserting a plurality of optical fibers 101 into the fiber block 102 may be formed, a plurality of optical waveguides may be formed in the PLC 310, and the plurality of optical fibers 101 may be connected to the respective input/output ends of the optical waveguides.

In addition, the optical module 300 according to the third embodiment explains a configuration of the optical fiber 101 being connected to the PLC 310 of a rib-type waveguide structure. However, instead of this, by using a PLC of the rib-type waveguide structure for at least one of them, the optical module of another configuration can be achieved. For example, in the optical module 200 described in the second embodiment, both the PLCs 110 and 210 may have the rib-type waveguide structure and the pair of PLCs may be connected to each other. However, in this case, the PLCs 110 and 210 have respective recessed portions recessed on the side of both side faces of the core layers 110B and 210B. Additionally, the UV cured resin adhesive layer 203 may adhesively bond the pair of PLCs 110 and 210, including filling areas of the recessed portions, to each other. Alternately, a PLC of rib-type waveguide structure on one hand and a PLC of embedded waveguide structure on the other hand may be used, and the pair of PLCs may be connected to each other. Accordingly, the optical modules of the present invention are not limited to the forms of the disclosed configuration.

1. An optical module comprising:
at least one optical waveguide;
at least one planar lightwave circuit, each of which is optically connected to a corresponding one of the at least one optical waveguide; and
an adhesive layer configured to bond and fix the optical waveguide to the planar lightwave circuit, wherein
a cladding region of the optical waveguide is partially removed in a region having a predetermined length in a light propagation direction from an input/output end,
a cladding region of the planar lightwave circuit is partially removed in a region having a predetermined length in a light propagation direction from an input/output end, and
a core of the optical waveguide and a core of the planar lightwave circuit are arranged to form a directional coupler.

2. The optical module according to claim 1, wherein
the optical module is configured by connecting an optical fiber to the planar lightwave circuit,
an optical waveguide of the at least one optical waveguide is individually provided in the optical fiber and the planar lightwave circuit, and
the optical waveguide in the optical fiber corresponds to the core of the optical waveguide and the optical waveguide in the planar lightwave circuit corresponds to the core of the planar lightwave circuit.

3. The optical module according to claim 2, wherein
the optical fiber is inserted into and fixed to a fiber block, and
the adhesive layer bonds and fixes the optical fiber inserted into and fixed to the fiber block to the planar lightwave circuit.

4. The optical module according to claim 2, wherein
the core of the optical fiber is rectangular in at least a region having a predetermined length in a light propagation direction from a end.

5. The optical module according to claim 4, wherein
the planar lightwave circuit has a rib-type waveguide structure having a recessed portion with both side faces of the core recessed,
a dimension of the planar lightwave circuit in a width direction perpendicular to a thickness direction in the core, the dimension being defined on a plane perpendicular to a length direction in which the core extends, is greater than a dimension of the optical fiber in a width direction perpendicular to a thickness direction in the core, the dimension being defined on a plane perpendicular to a length direction in which the core extends, and
the adhesive layer bonds and fixes the optical fiber to the planar lightwave circuit including a filling area of the recessed portion.

6. The optical module according to claim 1, wherein
the optical module is configured by connecting a pair of planar lightwave circuits of the at least one planar lightwave circuit, and
the optical waveguides are the cores separately provided in the pair of planar lightwave circuits.

7. The optical module according to claim 6, wherein
at least one of the pair of planar lightwave circuits has a rib-type waveguide structure having a recessed portion with both side faces of the core recessed, and
the adhesive layer bonds and fixes the pair of the plurality of planar lightwave circuits including a filling area of the recessed portion to each other.

8. The optical module according to claim 1, wherein
the adhesive layer is formed from one adhesive material selected from an ultraviolet cured resin, a thermosetting resin, and quartz-based glass.

9. The optical module according to claim 3, wherein
the core of the optical fiber is rectangular in at least a region having a predetermined length in a light propagation direction from a end.

10. The optical module according to claim 2, wherein
the adhesive layer is formed from one adhesive material selected from an ultraviolet cured resin, a thermosetting resin, and quartz-based glass.

11. The optical module according to claim 3, wherein
the adhesive layer is formed from one adhesive material selected from an ultraviolet cured resin, a thermosetting resin, and quartz-based glass.

12. The optical module according to claim 4, wherein
the adhesive layer is formed from one adhesive material selected from an ultraviolet cured resin, a thermosetting resin, and quartz-based glass.

13. The optical module according to claim 5, wherein
the adhesive layer is formed from one adhesive material selected from an ultraviolet cured resin, a thermosetting resin, and quartz-based glass.

14. The optical module according to claim 6, wherein
the adhesive layer is formed from one adhesive material selected from an ultraviolet cured resin, a thermosetting resin, and quartz-based glass.

15. The optical module according to claim 7, wherein
the adhesive layer is formed from one adhesive material selected from an ultraviolet cured resin, a thermosetting resin, and quartz-based glass.
